(19) United States
(12) Patent Application Publication
(10) Pub. No.: US 2026/0196758 A1
(43) Pub. Date: Jul. 9, 2026

(54) CABLE ASSEMBLY AND METHOD FOR MANUFACTURING CABLE ASSEMBLY

(71) Applicant: I-PEX Inc., Kyoto-shi (JP)

(72) Inventor: Yuki MIYAZAKI, Fukuoka (JP)

(21) Appl. No.: 19/558,484

(22) Filed: Mar. 6, 2026

Related U.S. Application Data
(63) Continuation of application No. PCT/JP2024/032279, filed on Sep. 9, 2024.

(30) Foreign Application Priority Data
Sep. 11, 2023 (JP) 2023-147085

(51) Int. Cl. H01R 12/79; H01R 13/6581

(52) U.S. Cl. CPC H01R 12/79; H01R 13/6581

(57) ABSTRACT

A cable assembly includes a plurality of cables arranged along an arrangement orientation and a connector connected to the plurality of cables. Each cable includes a conductive signal wire, a drain wire, an insulating inner sheath covering the signal wire, a conductive outer conductor covering the inner sheath, and an insulating outer sheath. The connector includes a plurality of conductive signal contacts, one or more conductive ground contacts located between adjacent signal contacts, and a conductive ground bar extending along the arrangement orientation. The ground bar includes connection pieces connected to the ground contacts. The plurality of signal contacts are connected to a plurality of signal wires exposed of the plurality of cables. The ground bar comprises a facing surface that faces outer circumferential surfaces of a plurality of inner sheaths exposed of the plurality of cables, and a plurality of drain wires are connected to the facing surface.

### CROSS-REFERENCE TO RELATED APPLICATIONS

This application is a continuation application of PCT Application No. PCT/JP2024/032279, filed on September 9, 2024, which claims the benefit of priority from Japanese Patent Application No. 2023-147085, filed on September 11, 2023. The entire contents of the above listed PCT and priority applications are incorporated herein by reference.

### BACKGROUND

### Field

The present disclosure relates to a cable assembly and method for manufacturing cable assembly.

### DESCRIPTION OF THE RELATED ART

U.S. Patent Application Publication No. 2023/0048710 discloses a configuration in which a ground wire of a cable is connected outside a ground portion that accommodates a signal wire of the cable.

### SUMMARY

Disclosed herein is a cable assembly. The cable assembly may include: a plurality of cables arranged along an arrangement orientation; and a connector connected to the plurality of cables, wherein each of the plurality of cables may include: a conductive signal wire and a drain wire that intersect the arrangement orientation; an insulating inner sheath that covers the signal wire; a conductive outer conductor that covers the inner sheath; and an insulating outer sheath that covers the outer conductor and the drain wire, wherein exposed portions of the signal wire, the inner sheath, and the outer conductor are arranged in this order from an end of the signal wire, and an end of the exposed drain wire is located between an end of the inner sheath and an end of the outer conductor, wherein the connector may include: a plurality of conductive signal contacts arranged along the arrangement orientation; one or more conductive ground contacts located between adjacent ones of the plurality of signal contacts along the arrangement orientation; a conductive ground bar extending along the arrangement orientation so as to span the plurality of cables; and one or more connection pieces that protrude from the ground bar and are respectively connected to the one or more ground contacts, wherein the plurality of signal contacts are respectively connected to a plurality of signal wires exposed of the plurality of cables, wherein the ground bar comprises a facing surface that faces outer circumferential surfaces of a plurality of inner sheaths exposed of the plurality of cables, and wherein a plurality of drain wires exposed of the plurality of cables are connected to the facing surface.

Additionally, a method for manufacturing a cable assembly by attaching a connector to a plurality of cables each comprising a conductive signal wire and a drain wire, an insulating inner sheath that covers the signal wire, a conductive outer conductor that covers the inner sheath and the drain wire, and an insulating outer sheath that covers the outer conductor and the drain wire, is disclosed herein. The method may include: forming, in each of the plurality of cables, an end portion in which exposed portions of the signal wire, the inner sheath, and the outer conductor are arranged in this order from an end of a signal wire; cutting the drain wire such that, at the end portion of each of the plurality of cables, an end of the drain wire is located between an end of the exposed inner sheath and an end of the exposed outer conductor; arranging the plurality of cables along an arrangement orientation; causing a facing surface of a ground bar extending along the arrangement orientation to face the inner sheath exposed of each of the plurality of cables; connecting the drain wire exposed of each of the plurality of cables to the facing surface; connecting the signal wire exposed of each of the plurality of cables to any of a plurality of signal contacts arranged along the arrangement orientation; and connecting one or more connection pieces protruding from the ground bar respectively to one or more conductive ground contacts located between adjacent ones of the plurality of signal contacts along the arrangement orientation.

### BRIEF DESCRIPTION OF THE DRAWINGS

FIG. 1 is a perspective view of a connector system.

FIG. 2 is an exploded perspective view of a mating connector.

FIG. 3 is a perspective view of an end portion of a cable.

FIG. 4 is an exploded perspective view of a connector.

FIG. 5 is a plan view of an inner unit.

FIG. 6 is an exploded perspective view of the inner unit.

FIG. 7 is a cross-sectional view taken along line VII-VII in FIG. 6.

FIG. 8 is a side view of a plurality of cables, a ground bar, and a second ground bar.

FIG. 9 is a perspective view of an outer shell.

FIG. 10 is a perspective view of the outer shell.

FIG. 11 is a cross-sectional view taken along line XI-XI in FIG. 1.

FIG. 12 is a perspective view illustrating a state in which the connector is connected to the mating connector.

FIG. 13 is a perspective view illustrating an assembly procedure of the cable assembly.

FIG. 14A and 14B is a cross-sectional view illustrating an assembly procedure of the cable assembly.

FIG. 15 is a perspective view illustrating an assembly procedure of the cable assembly.

FIG. 16 is a cross-sectional view of a cable according to a modified example.

FIG. 17 is a cross-sectional view of a cable according to a modified example.

FIG. 18 is a cross-sectional view of a cable according to a modified example.

FIG. 19 is a cross-sectional view of a cable according to a modified example.

### DETAILED DESCRIPTION

In the following description, with reference to the drawings, the same reference numbers are assigned to the same components or to similar components having the same function, and overlapping description is omitted.

### Connector System

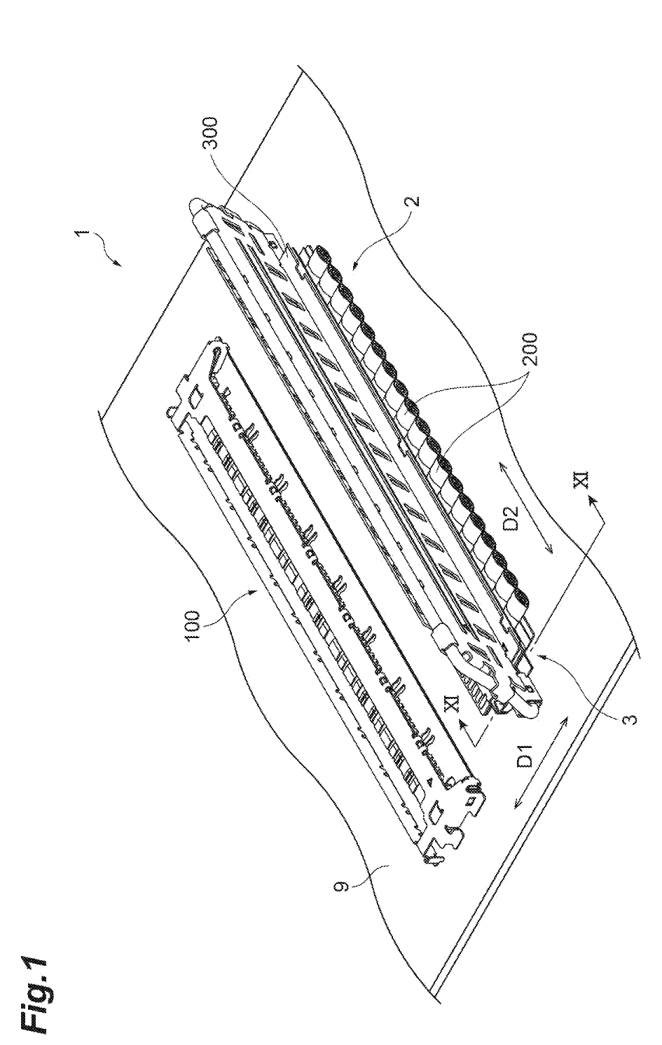

A connector system 1 illustrated in FIG. 1 is a system that connects a circuit formed on a circuit board 9 and a peripheral circuit. The connector system 1 connects the circuit and the peripheral circuit in a computer such as a server device, for example. The peripheral circuit may be formed on the circuit board 9, or may be formed on a device or a board separated from the circuit board 9. The connector system 1 includes a mate connector 100 and a cable assembly 2. The mate connector 100 is connected to the circuit board 9. The cable assembly 2 includes a plurality of cables 200 and an outer shell 300 connected to one end of the plurality of cables 200. For example, the outer shell 300 is connected to the mate connector 100 in a detachable state. For example, the outer shell 300 is mated with the mate connector 100 along a mating orientation D1 parallel to a surface of the circuit board 9. By mating the outer shell 300 and the mate connector 100, the plurality of cables 200 are connected to the circuit board 9. The cable assembly 2 may further include another end connector connected to the other end of the plurality of cables 200. The other end connector is connected to another end mate connector in a detachable state, for example, when the other end mate connector is connected to the peripheral circuit. The other end connector may be the same as the outer shell 300, or may have a structure different from the outer shell 300.

Hereinafter, in the description of the mate connector 100, for convenience, an upward direction is a direction away from the surface of the circuit board 9, and a forward direction is a direction toward the outer shell 300. In the description of the outer shell 300, for convenience, an upward direction is a direction away from the surface of the circuit board 9, and a forward direction is a direction toward the mate connector 100.

### Mate Connector

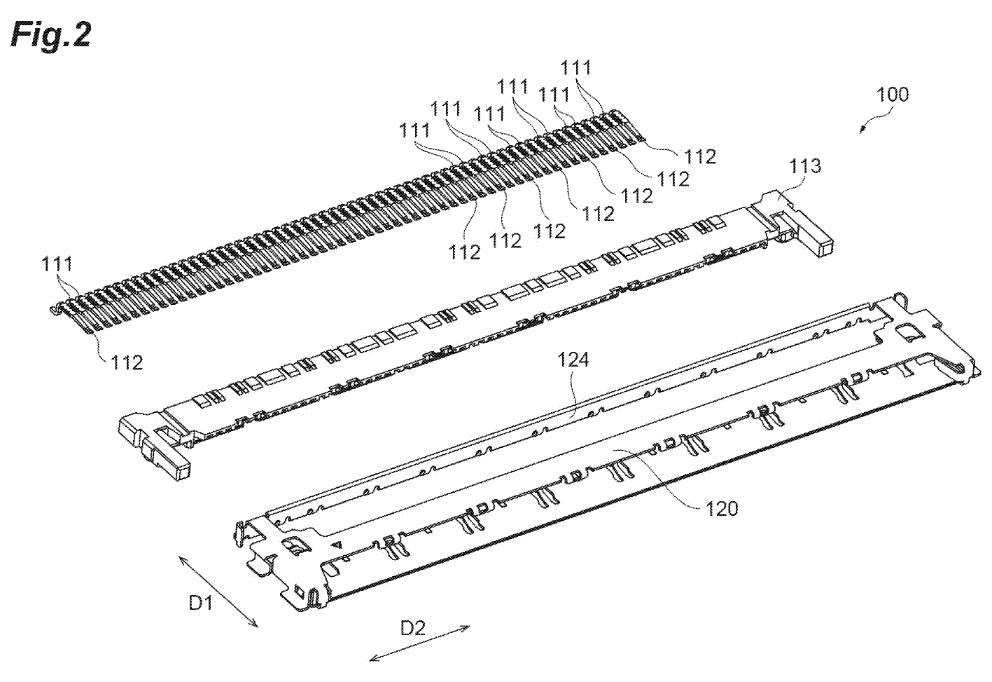

As illustrated in FIG. 2, the mate connector 100 includes a plurality of signal contacts 111, one or more ground contacts 112, a housing 113, and a shell 120. The plurality of signal contacts 111 are arranged along an arrangement orientation D2 that is parallel to the surface of the circuit board 9 and perpendicular to the mating orientation D1. Each of the plurality of signal contacts 111 has conductivity and is respectively connected to a plurality of signal wires of the circuit board 9. The one or more ground contacts 112 are located between adjacent ones of the plurality of signal contacts 111 along the arrangement orientation D2. Each of the one or more ground contacts 112 has conductivity and is respectively connected to a ground of the circuit board 9. Each of the plurality of signal contacts 111 and the one or more ground contacts 112 is formed, for example, by press working or the like of a thin metal plate material such as copper.

The plurality of signal contacts 111 may include a plurality of pairs of signal contacts 111 arranged along the arrangement orientation. Each of the plurality of pairs of signal contacts 111 transmits one electrical signal by a potential difference between each other. The mate connector 100 may include, as an example of the one or more ground contacts 112, a plurality of ground contacts 112. The plurality of ground contacts 112 are alternately arranged with the plurality of pairs of signal contacts 111 along the arrangement orientation D2. Two of the ground contacts 112 are located at both ends of the arrangement of the plurality of pairs of signal contacts 111 and the plurality of ground contacts 112.

The housing 113 has insulating properties and holds the plurality of pairs of signal contacts 111 and the plurality of ground contacts 112 in a state of being insulated from each other. The housing 113 is formed, for example, by injection molding of a resin material.

The shell 120 has conductivity and at least partially surrounds the plurality of pairs of signal contacts 111 and the plurality of ground contacts 112 about the mating orientation D1. The housing 113 holds the shell 120 in a state of being insulated from the plurality of pairs of signal contacts 111 and the plurality of ground contacts 112. The shell 120 opens toward the front and mates with the outer shell 300, which is inserted rearward. The shell 120 includes a back plate 124. The back plate 124 extends perpendicularly to the mating orientation D1 so as to face the housing 113 across a gap on the rear side. The plurality of pairs of signal contacts 111 and the ground contacts 112 protrude between the back plate 124 and the housing 113. The plurality of pairs of signal contacts 111 are respectively connected to a plurality of pairs of signal conductors of the circuit board 9 between the back plate 124 and the housing 113. The plurality of ground contacts 112 are respectively connected to ground conductors of the circuit board 9 between the back plate 124 and the housing 113.

### Cable Assembly

Returning to FIG. 1, the cable assembly 2 includes a plurality of cables 200 and an outer shell 300. The plurality of cables 200 are arranged along the arrangement orientation D2. The outer shell 300 is connected to the plurality of cables 200. The outer shell 300 connected to the plurality of cables 200 is connected to the mate connector 100 along the mating orientation D1 in a detachable state.

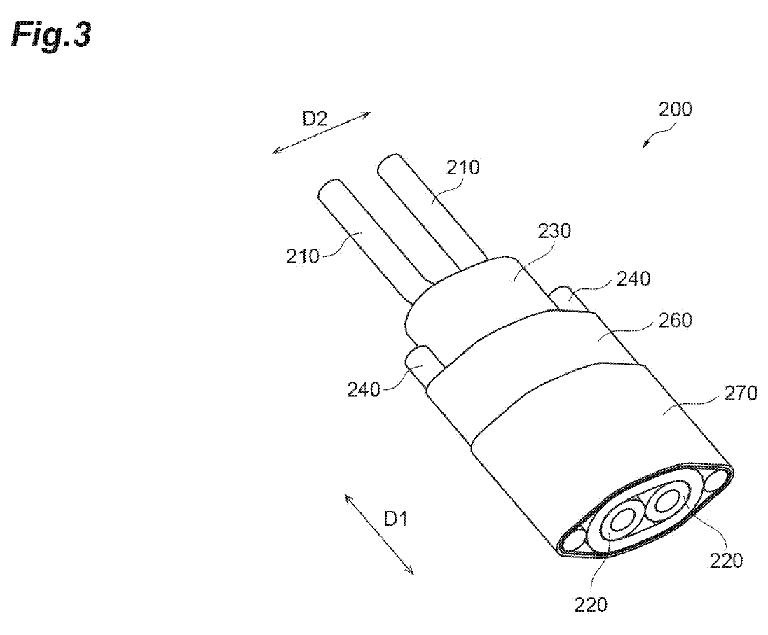

As illustrated in FIG. 3, the cable 200 (each of the plurality of cables 200) includes at least a signal wire 210 and a drain wire 240, an inner sheath 230, an outer conductor 260, and an outer sheath 270. The signal wire 210 has conductivity and extends so as to intersect the arrangement orientation D2. For example, the signal wire 210 extends along the mating orientation D1. The signal wire 210 is, for example, a copper wire. The signal wire 210 connects a signal conductor of the circuit of the circuit board 9 and a signal conductor of the peripheral circuit. The drain wire 240 has conductivity and extends so as to intersect the arrangement orientation D2. For example, the drain wire 240 extends along the mating orientation D1. The drain wire 240 is, for example, a copper wire. The drain wire 240 connects a ground conductor of the circuit of the circuit board 9 and a ground conductor of the peripheral circuit. By the drain wire 240, a ground potential of the circuit of the circuit board 9 and a ground potential of the peripheral circuit are maintained at an equivalent level.

The inner sheath 230 has insulating properties and covers the signal wire 210. The outer conductor 260 has conductivity and covers the inner sheath 230 and the drain wire 240. The outer conductor 260 may be made of a material that is difficult to solder, such as aluminum foil. The outer sheath 270 has insulating properties and covers the outer conductor 260.

The cable 200 is processed such that an outer circumferential surface of the exposed signal wire 210, an outer circumferential surface of the exposed inner sheath 230, and an outer circumferential surface of the exposed outer conductor 260 are arranged in this order from one end of the signal wire 210 along the mating orientation D1. An end of the drain wire 240 is located between an end of the inner sheath 230 and an end of the outer conductor 260 in the mating orientation D1, and an outer circumferential surface of the drain wire 240 is exposed between the end of the inner sheath 230 and the end of the outer conductor 260.

The cable 200 may include a pair of drain wires 240 including the drain wire 240. In the arrangement orientation D2, the signal wire 210 may be located between the pair of drain wires 240. When the cable 200 includes the pair of drain wires 240, each end of the pair of drain wires 240 is located between the end of the inner sheath 230 and the end of the outer conductor 260 in the mating orientation D1.

The cable 200 may include a pair of signal wires 210 including the signal wire 210 described above. Each of the plurality of cables 200 may further include a pair of insulating individual sheaths 220 that respectively cover the pair of signal wires 210, and the inner sheath 230 may cover the pair of individual sheaths 220.

The cable 200 is processed such that outer circumferential surfaces of the exposed pair of signal wires 210, an outer circumferential surface of the exposed inner sheath 230, and an outer circumferential surface of the exposed outer conductor 260 are arranged in this order from one end of the pair of signal wires 210 along the mating orientation D1. Examples of the cable 200 including the pair of signal wires 210 and the pair of drain wires 240 include an MCIO cable and the like.

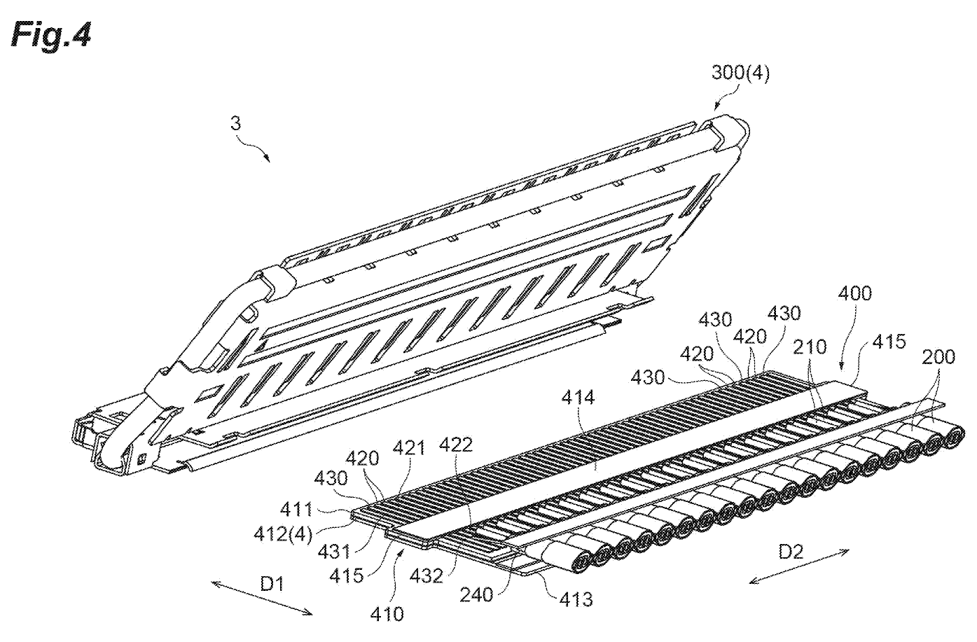

FIG. 4 is an exploded perspective view of the connector 3. As illustrated in FIG. 4, the connector 3 includes an inner unit 400 and an outer shell 300.

The inner unit 400 is connected to the plurality of cables 200. The outer shell 300 has conductivity and surrounds at least a part of the inner unit 400 about the mating orientation D1.

The plurality of cables 200 are arranged along the arrangement orientation D2. In each of the plurality of cables 200, the drain wire 240 may be arranged alongside the signal wire 210 along the arrangement orientation D2. The plurality of cables 200 may be arranged such that, between two adjacent cables 200, the drain wire 240 and the drain wire 240 face each other along the arrangement orientation D2.

For example, in each of the plurality of cables 200 arranged along the arrangement orientation D2, a pair of signal wires 210 are arranged along the arrangement orientation D2, and a pair of signal wires 210 are located between the pair of drain wires 240 along the arrangement orientation D2. As a result, between two adjacent cables 200, the drain wire 240 of one cable 200 and the drain wire 240 of the other cable 200 face each other along the arrangement orientation D2.

The inner unit 400 includes a plurality of signal contacts 420 and one or more ground contacts 430. The plurality of signal contacts 420 are arranged along the arrangement orientation D2. Each of the plurality of signal contacts 420 has conductivity. The signal wires 210 of the plurality of cables 200 are respectively directly connected to the plurality of signal contacts 420. In a state in which the outer shell 300 is mated with the mate connector 100, the plurality of signal contacts 420 respectively contact the plurality of signal contacts 111 of the mate connector 100. Being directly connected includes being connected via a bonding material (a material intended for bonding) such as solder. The same applies hereinafter. The one or more ground contacts 430 are located between adjacent ones of the plurality of signal contacts 420 along the arrangement orientation D2. Each of the one or more ground contacts 430 has conductivity. The drain wires 240 of the plurality of cables 200 are indirectly connected to the one or more ground contacts 430. In a state in which the connector 3 is mated with the mate connector 100, the one or more ground contacts 430 respectively contact the one or more ground contacts 112 of the mate connector 100. Being indirectly connected means being connected via a structural material other than a bonding material.

For example, the inner unit 400 includes a contact unit 410. The contact unit 410 is a unit in which the plurality of signal contacts 420 and the one or more ground contacts 430 are integrated. The contact unit 410 includes the plurality of signal contacts 420, the one or more ground contacts 430, a base 411, and a contact cover 414.

The base 411 has insulating properties and supports the plurality of signal contacts 420 and the one or more ground contacts 430 from below. The base 411 may be an insulating substrate, or may be a housing formed by injection molding of a resin material or the like. For example, the base 411 is a substrate that extends along the mating orientation D1 and the arrangement orientation D2. The contact cover 414 has insulating properties and extends along the arrangement orientation D2 so as to partially cover each of the plurality of signal contacts 420 and each of the one or more ground contacts 430 from above. The contact cover 414 is fixed to the base 411 between the signal contacts 420 and between the signal contacts 420 and the ground contacts 430.

Each of the plurality of signal contacts 420 includes a contact portion 421 and a connection portion 422. The contact portion 421 is located forward of the contact cover 414, and the connection portion 422 is located rearward of the contact cover 414. The contact portion 421 contacts a corresponding signal contact 111 among the plurality of signal contacts 111. The signal wire 210 of a corresponding cable 200 among the plurality of cables 200 is connected to the connection portion 422.

Each of the one or more ground contacts 430 includes a contact portion 431 and a connection portion 432. The contact portion 431 is located forward of the contact cover 414, and the connection portion 432 is located rearward of the contact cover 414. The contact portion 431 contacts a corresponding ground contact 112 among the one or more ground contacts 112. The drain wires 240 of the plurality of cables 200 are indirectly connected to the connection portion 432.

In the base 411, the plurality of signal contacts 420 and the one or more ground contacts 430 may be arranged at a constant pitch along the arrangement orientation D2. The pitch is, for example, a center-to-center distance. For example, a center-to-center distance between adjacent signal contacts 420 and a center-to-center distance between an adjacent signal contact 420 and a ground contact 430 may be constant in the arrangement orientation D2.

The contact unit 410 may further include an inner shell 412. The inner shell 412 has conductivity and supports the base 411 from below. The inner shell 412 extends along the mating orientation D1 and the arrangement orientation D2 so as to at least partially cover a lower surface of the base 411. The inner shell 412 includes a shell plate 413 (second shell plate) that projects rearward from the base 411. The base 411 partitions between the plurality of signal contacts 420 and the one or more ground contacts 430, and the inner shell 412.

The base 411 and the inner shell 412 include a pair of protrusions 415, 415 that protrude in opposite directions along the arrangement orientation D2. The pair of protrusions 415, 415 and the contact cover 414 described above are used for positioning within the outer shell 300, as will be described later.

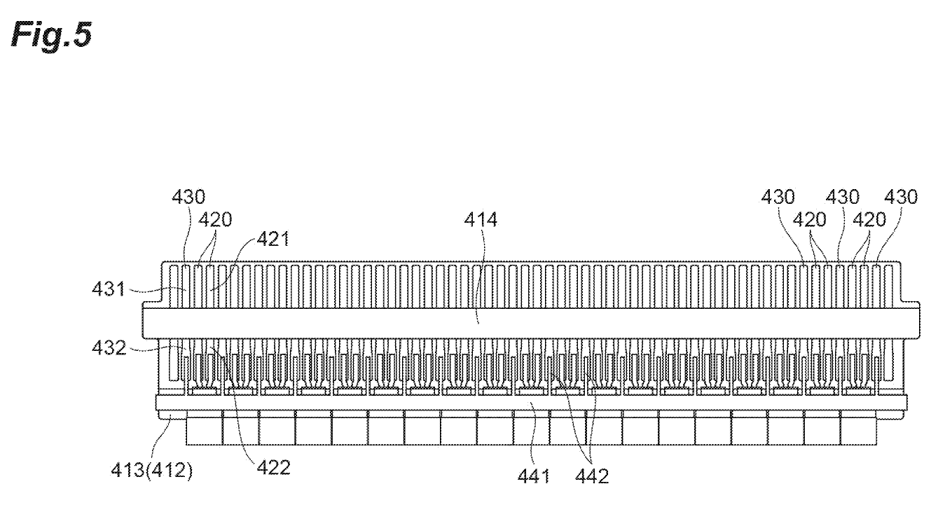

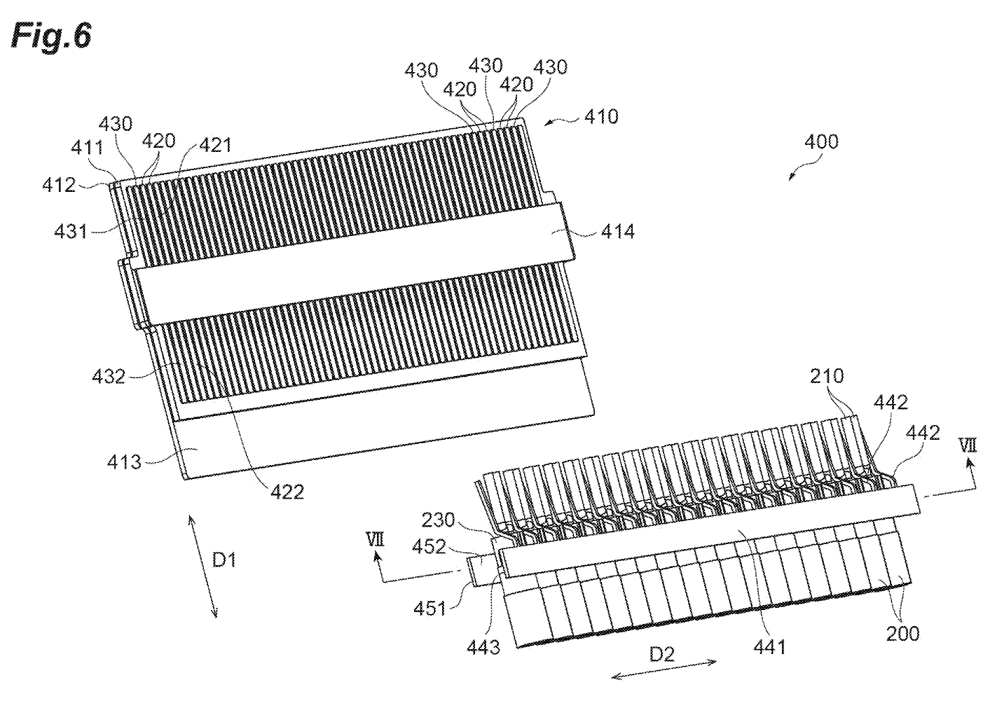

FIG. 5 is a plan view of the contact unit 410. FIG. 6 is a perspective view illustrating a state in which the plurality of cables 200 are separated from the contact unit 410. As illustrated in FIGS. 5 and 6, the inner unit 400 further includes a ground bar 441 and one or more connection pieces 442.

The ground bar 441 has conductivity and extends along the arrangement orientation D2 so as to span the plurality of cables 200. For example, the ground bar 441 is a flat plate that extends along the mating orientation D1 and the arrangement orientation D2, and includes a facing surface 443. The facing surface 443 faces downward and faces the outer circumferential surface of the inner sheath 230 exposed of each of the plurality of cables 200. The drain wire 240 exposed of each of the plurality of cables 200 is directly connected to the facing surface 443.

Each of the one or more connection pieces 442 protrudes from the ground bar 441 and is respectively directly connected to the one or more ground contacts 430. For example, each of the one or more connection pieces 442 is directly connected to the connection portion 432 of a corresponding ground contact 430 among the one or more ground contacts 430. As a result, the drain wires 240 of the plurality of cables 200 are indirectly connected to the one or more ground contacts 430.

The number of the one or more connection pieces 442 may be smaller than the number of the drain wires 240 of the plurality of cables 200. For example, the inner unit 400 may include one connection piece 442 for each combination of drain wires 240 that face each other along the arrangement orientation D2.

As illustrated in FIG. 6, the inner unit 400 includes a plurality of pairs of signal contacts 420 and a plurality of ground contacts 430. The plurality of pairs of signal contacts 420 respectively contact the plurality of pairs of signal contacts 111 of the mate connector 100. Each of the plurality of pairs of signal contacts 420 transmits one electrical signal by a potential difference between each other.

The plurality of ground contacts 430 are alternately arranged with the plurality of signal contacts 420 along the arrangement orientation D2. Two ground contacts 430 are respectively located at both ends of the arrangement of the plurality of pairs of signal contacts 420 and the plurality of ground contacts 430.

The plurality of pairs of signal contacts 420 respectively correspond to the plurality of cables 200. The pair of signal wires 210 of a corresponding cable 200 are respectively directly connected to the connection portion 422 of each of the plurality of pairs of signal contacts 420 by soldering or the like.

The inner unit 400 includes a plurality of connection pieces 442 respectively corresponding to the plurality of ground contacts 430. The plurality of connection pieces 442 are alternately arranged with the plurality of pairs of signal wires 210 in the arrangement orientation D2. Two connection pieces 442 are respectively located at both ends of the arrangement of the plurality of pairs of signal wires 210 and the plurality of connection pieces 442.

Each of the plurality of connection pieces 442 protrudes forward from the ground bar 441, bends downward, and is directly connected to the connection portion 432 of a corresponding ground contact 430 by soldering or the like. Except for the two connection pieces 442, each of the plurality of connection pieces 442 is located between two adjacent pairs of signal wires 210 and corresponds to a set of the drain wire 240 and the drain wire 240 that face each other along the arrangement orientation D2.

In the above example, the number of the drain wires 240 is twice the number of the cables 200. In contrast, the number of the connection pieces 442 is a number obtained by adding 1 to the number of the cables 200, and is therefore smaller than the number of the drain wires 240. The ground bar 441 and the plurality of connection pieces 442 may be integrally formed by press working or the like on a thin metal plate material such as copper.

The inner unit 400 may further include a second ground bar 451. The second ground bar 451 has conductivity and extends along the arrangement orientation D2 so as to span the plurality of cables 200. For example, the second ground bar 451 is a flat plate that extends along the mating orientation D1 and the arrangement orientation D2, and includes a second facing surface 452. The second facing surface 452 faces upward and faces the outer circumferential surface of the inner sheath 230 exposed of each of the plurality of cables 200. The inner sheath 230 exposed of each of the plurality of cables 200 is located between the facing surface 443 of the ground bar 441 and the second facing surface 452 of the second ground bar 451. The exposed drain wire 240 of each of the plurality of cables 200 is directly connected to both the facing surface 443 and the second facing surface 452.

The second ground bar 451 is located between the inner sheaths 230 of the plurality of cables 200 and the shell plate 413 of the inner shell 412. The second ground bar 451 may be directly connected to the shell plate 413 by soldering or the like.

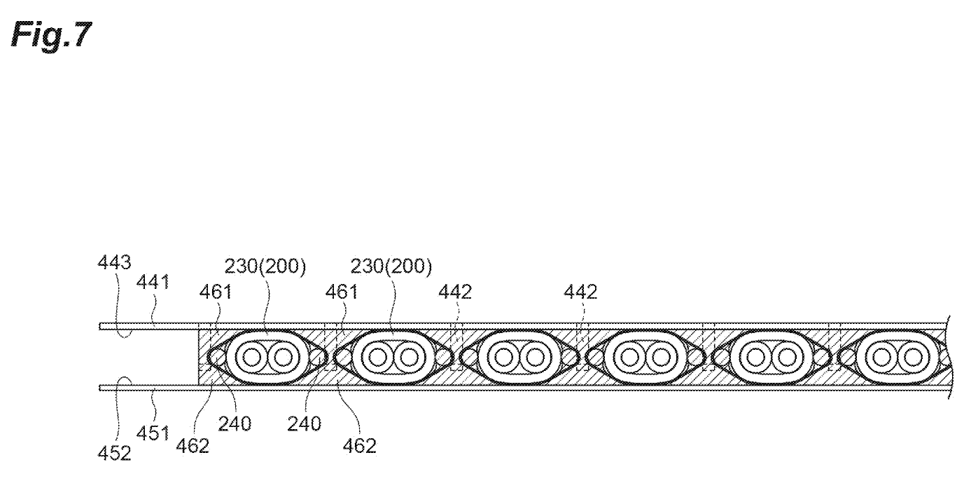

FIG. 7 is a cross-sectional view taken along line VII-VII in FIG. 6. As illustrated in FIG. 7, the exposed drain wires 240 of each of the plurality of cables 200 are directly connected to both the ground bar 441 and the second ground bar 451 by solder 461 filled between the drain wires 240 and the ground bar 441 (between the drain wires 240 and the facing surface 443) and solder 462 filled between the drain wires 240 and the second ground bar 451 (between the drain wires 240 and the second facing surface 452).

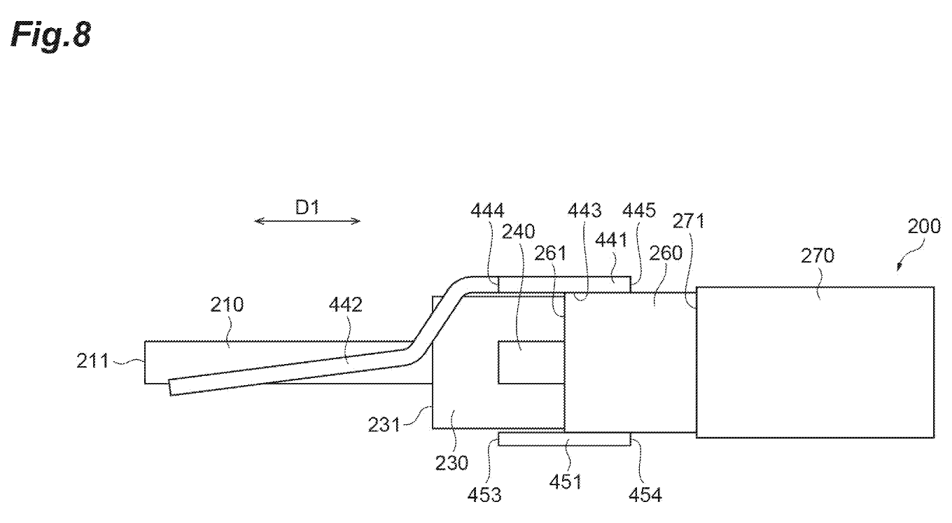

FIG. 8 is a side view of the cable 200, the ground bar 441, and the second ground bar 451 as viewed from a direction along the arrangement orientation D2. As illustrated in FIG. 8, the ground bar 441 includes a first edge 444 and a second edge 445. The first edge 444 is directed toward an end 211 of the signal wire 210. The second edge 445 is directed toward an end 271 of the outer sheath 270.

An end 231 of the exposed inner sheath 230 is located between the end 211 of the exposed signal wire 210 and the first edge 444. Reliability of insulation between the signal wire 210 and the drain wire 240 can be improved. The second edge 445 is located between the end 231 of the exposed inner sheath 230 and the end 271 of the outer sheath 270. An end 261 of the exposed outer conductor 260 may be located between the first edge 444 and the second edge 445. The ground bar 441 can also be used to hold the exposed outer conductor 260.

Similarly to the ground bar 441, the second ground bar 451 includes a first edge 453 and a second edge 454. The first edge 453 is directed toward the end 211 of the signal wire 210. The second edge 454 is directed toward the end 271 of the outer sheath 270.

The end 231 of the exposed inner sheath 230 is located between the end 211 of the exposed signal wire 210 and the first edge 453. Reliability of insulation between the signal wire 210 and the drain wire 240 can be improved. The second edge 454 is located between the end 231 of the exposed inner sheath 230 and the end 271 of the outer sheath 270. The end 261 of the exposed outer conductor 260 may be located between the first edge 453 and the second edge 454. The second ground bar 451 can also be used for holding the exposed outer conductor 260.

The configurations of the plurality of cables 200 and the inner unit 400 illustrated above are examples and can be changed. For example, the cable 200 may not include a pair of signal wires 210 and a pair of drain wires 240, and may include at least one signal wire 210 and at least one drain wire 240. The signal wire 210 and the drain wire 240 may not be arranged along the arrangement orientation D2. For example, the signal wire 210 and the drain wire 240 may be arranged along a direction perpendicular to the mating orientation D1 and the arrangement orientation D2.

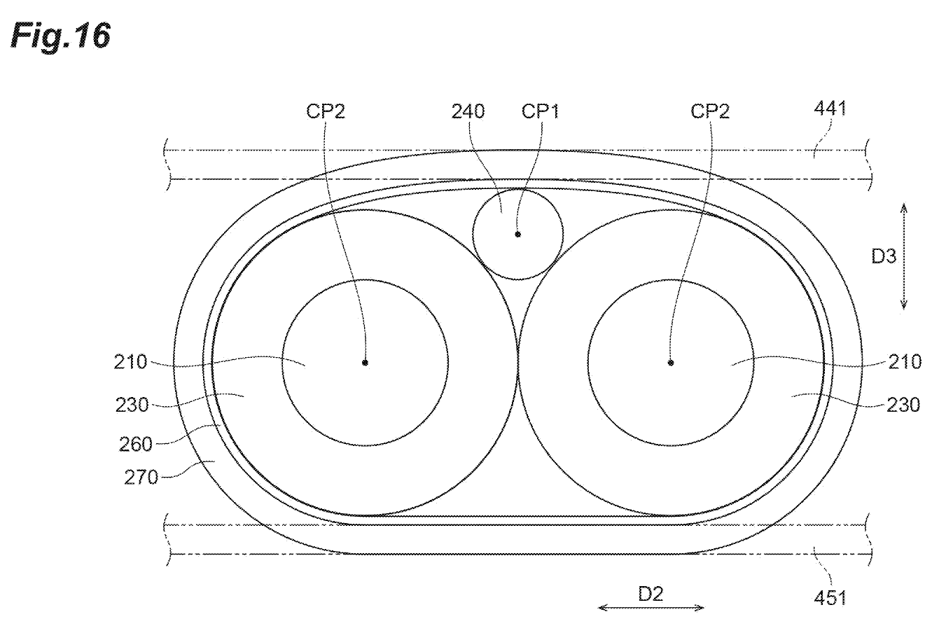

For example, as illustrated in FIG. 16, each of the plurality of cables 200 may include a pair of signal wires 210 arranged along the arrangement orientation D2 and a pair of inner sheaths 230 that respectively cover the pair of signal wires 210. For example, a pair of individual sheaths 220 may be used as a pair of inner sheaths 230, and the inner sheath 230 that covers the pair of individual sheaths 220 may be omitted.

A center CP1 of the drain wire 240 may be located, in the arrangement orientation D2, between centers CP2 of a pair of signal wires 210. The center CP1 of the drain wire 240 may be located, in an orthogonal orientation D3 perpendicular to the arrangement orientation D2 and the mating orientation D1, between each of the centers CP2 of a pair of signal wires 210 and the ground bar 441.

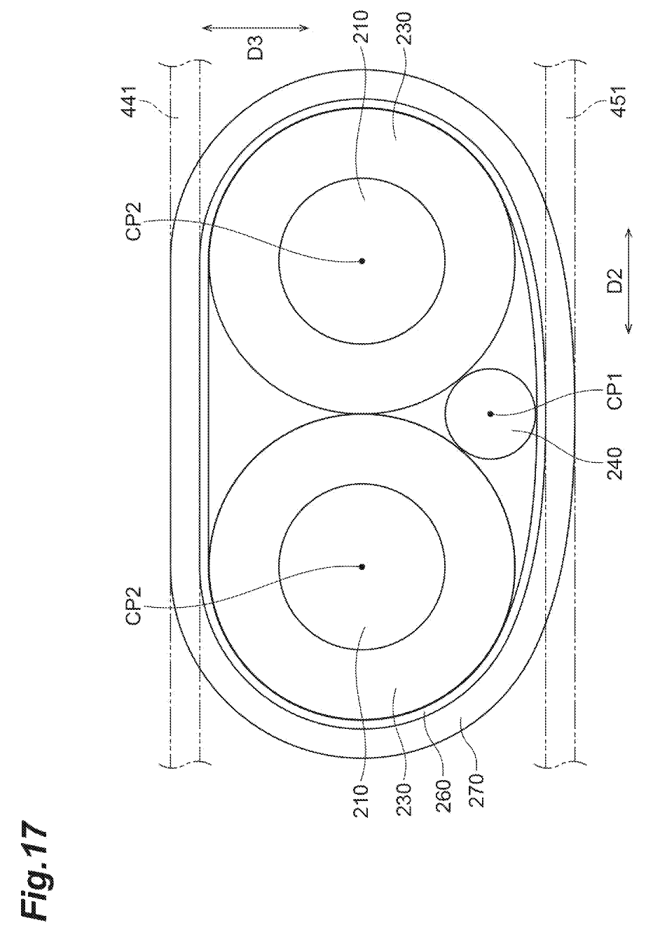

As illustrated in FIG. 17, each of the centers CP2 of a pair of signal wires 210 may be located, in the orthogonal orientation D3, between the center CP1 of the drain wire 240 and the ground bar 441.

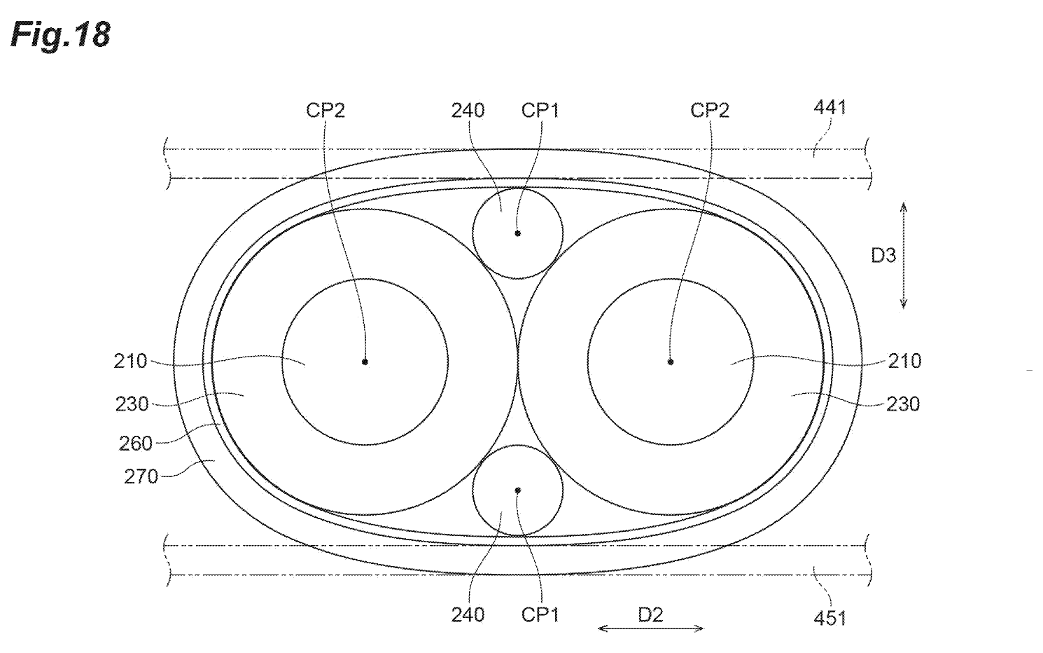

As illustrated in FIG. 18, each of the centers CP2 of the pair of signal wires 210 may be located, in the orthogonal orientation D3, between centers CP1 of the pair of drain wires 240.

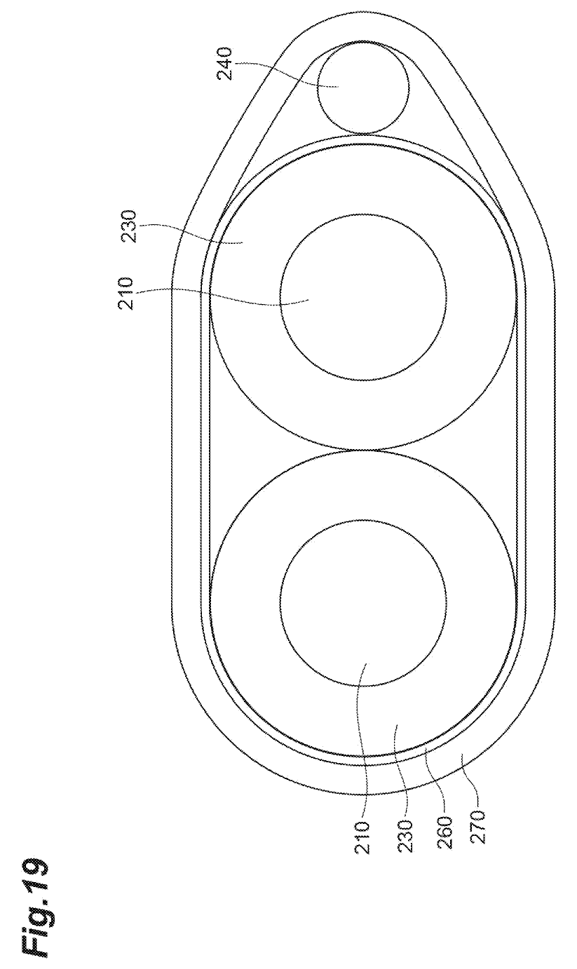

As illustrated in FIG. 19, the drain wire 240 may not be covered by the outer conductor 260, and the drain wire 240 may be located outside the outer conductor 260. In both cases where the drain wire 240 is covered by the outer conductor 260 and where the drain wire 240 is located outside the outer conductor 260, the outer sheath 270 covers the outer conductor 260 and the drain wire 240.

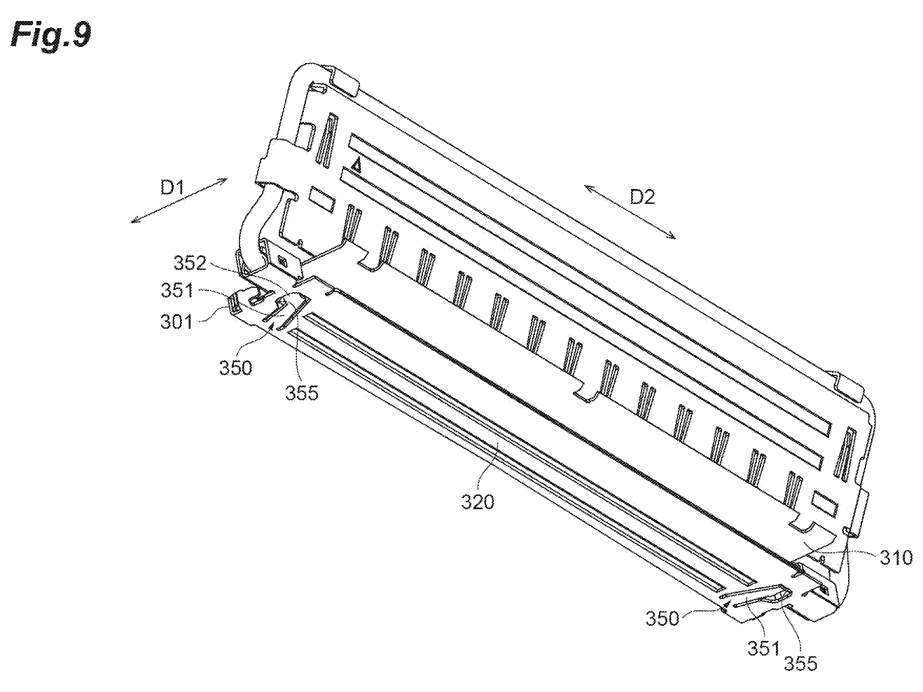

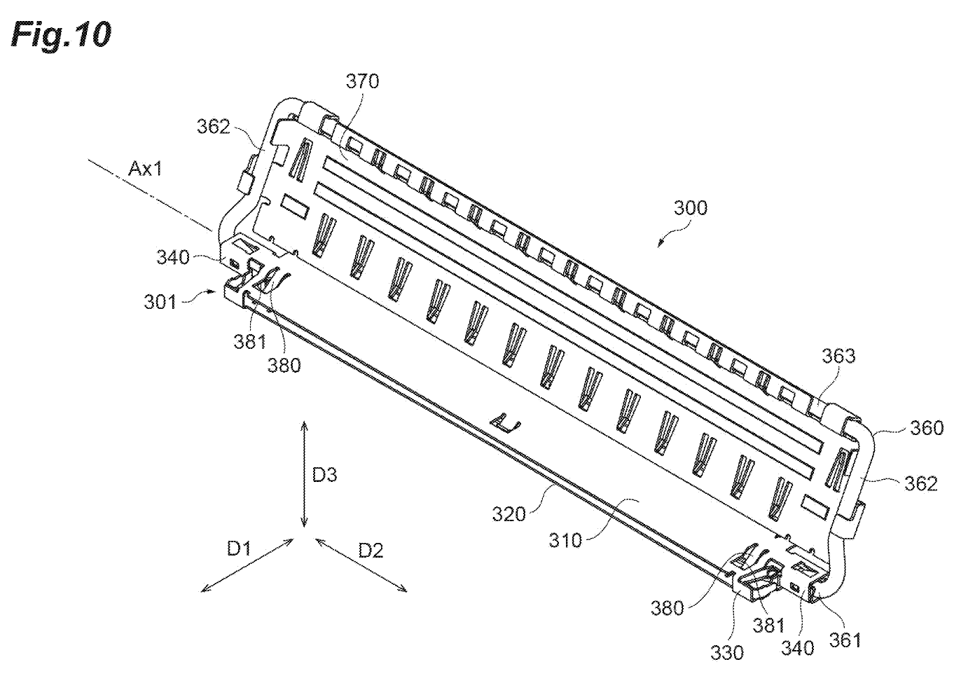

FIGS. 9 and 10 are perspective views of the outer shell 300. As illustrated in FIGS. 9 and 10, the outer shell 300 includes a main body 301 and a lock bar 360. The main body 301 has conductivity and is attached to the inner unit 400 so as to surround the base 411 and the inner shell 412 about the mating orientation D1. The lock bar 360 is attached to the main body 301 so as to rotate about an axis along the arrangement orientation D2, and switches, by rotation with respect to the main body 301, between a locked state that prevents the connector 3 from being detached from the mate connector 100 and an unlocked state that allows the connector 3 to be removed from the mate connector 100.

The main body 301 includes shell plates 310, 320, a front plate 330, and a pair of bearing portions 340, 340. The shell plate 310 and the shell plate 320 face each other along an orthogonal orientation D3 perpendicular to the mating orientation D1 and the arrangement orientation D2. The front plate 330 connects a front edge of the shell plate 310 and a front edge of the shell plate 320, and opens forward.

The pair of bearing portions 340, 340 protrude from the shell plates 310, 320 in opposite directions along the arrangement orientation D2. Each of the pair of bearing portions 340, 340 opens in a direction away from the shell plates 310, 320 along the arrangement orientation D2. The main body 301 is integrally formed, for example, by press working and bending of a thin metal plate material such as copper.

In a state in which the main body 301 is attached to the inner unit 400, the shell plate 310 covers at least a part of an upper surface of the inner unit 400, and the shell plate 320 covers at least a part of a lower surface of the inner unit 400. A portion of the inner unit 400 located forward of the contact cover 414 protrudes forward from an opening of the front plate 330. As a result, the contact portion 421 of each of the plurality of signal contacts 420 and the contact portion 431 of each of the one or more ground contacts 430 are exposed upward outside the main body 301.

The lock bar 360 includes a pair of shaft portions 361, 361, a pair of side bars 362, 362, and a connection bar 363. The pair of shaft portions 361, 361 are respectively held by the pair of bearing portions 340, 340 so as to rotate about an axis Ax1 along the arrangement orientation D2. For example, the pair of shaft portions 361, 361 are respectively inserted into the pair of bearing portions 340, 340 toward the shell plates 310, 320.

The pair of side bars 362, 362 are respectively connected to the pair of shaft portions 361, 361 and extend in a direction away from the axis Ax1. The connection bar 363 extends along the arrangement orientation D2 and connects ends of the pair of side bars 362, 362. By rotation of the lock bar 360 about the axis Ax1, the connection bar 363 moves between a lock position in front of the main body 301 and a release position above the main body 301. The mate connector 100 mated with the outer shell 300 is located between the connection bar 363 at the lock position and the main body 301.

In a state in which the connection bar 363 is at the lock position, when a force acts on the main body 301 in a direction away from the mate connector 100, the connection bar 363 engages with the back plate 124 of the mate connector 100, and detachment of the connector 3 is prevented. When the connection bar 363 is at the release position, the connection bar 363 does not engage with the back plate 124, so the connector 3 can be removed from the mate connector 100. The lock bar 360 is integrally formed, for example, by bending of a metal wire material.

As illustrated in FIG. 9, the shell plate 320 includes a pair of cantilevers 350, 350. The pair of cantilevers 350, 350 are respectively provided near both ends of the shell plate 320 in the arrangement orientation D2. For example, the pair of cantilevers 350, 350 are respectively formed in a pair of openings 355, 355 formed in the shell plate 320.

Each of the pair of cantilevers 350, 350 includes an elastic beam 351 and a hook 352. The elastic beam 351 extends rearward within the opening 355. The hook 352 protrudes upward (into the main body 301) from an end of the elastic beam 351. The hook 352 includes a guide edge 353. The guide edge 353 is inclined so as to move away from the elastic beam 351 toward the front.

As illustrated in FIG. 10, the shell plate 310 includes a pair of clamps 380, 380. The pair of clamps 380, 380 are respectively provided near both ends of the shell plate 310 in the arrangement orientation D2. For example, the pair of clamps 380, 380 are respectively formed in a pair of openings 381, 381 formed in the shell plate 310. Each of the pair of clamps 380, 380 protrudes forward within the opening 381 and is bent downward (into the main body 301).

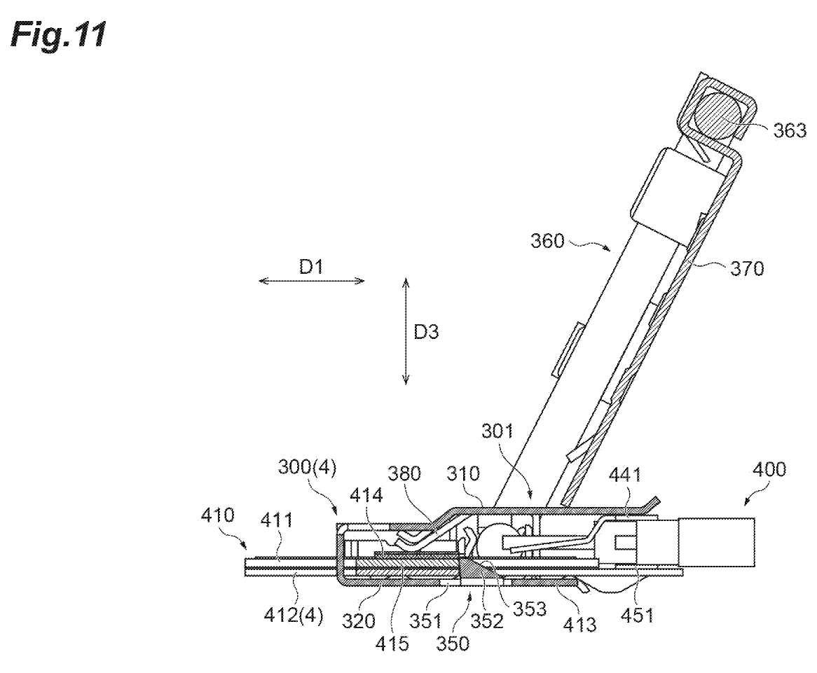

FIG. 11 is a cross-sectional view taken along line XI-XI in FIG. 1. As illustrated in FIG. 11, in a state in which the outer shell 300 is attached to the contact unit 410, the pair of cantilevers 350, 350 respectively engage with the rear of the pair of protrusions 415, 415, and prevent the contact unit 410 from being displaced rearward with respect to the outer shell 300. The pair of clamps 380, 380 contact the contact cover 414 and press the contact unit 410 toward the shell plate 320. As a result, the contact unit 410 is positioned with respect to the outer shell 300.

As will be described later, the inner unit 400 is inserted into the main body 301 from the rear. In the insertion process, each of the pair of protrusions 415, 415 contacts the guide edge 353 of the corresponding cantilever 350 and applies a downward force to the hook 352. As the inner unit 400 advances with respect to the main body 301, the hook 352 is displaced downward by the elasticity of the elastic beam 351. When each of the pair of protrusions 415, 415 passes the corresponding hook 352, the elastic beam 351 elastically returns. As a result, the hook 352 engages with the rear of the corresponding protrusion 415.

The shell plate 310 is directly connected to the ground bar 441 from above, and the shell plate 320 is directly connected to the inner shell 412 from below (the side opposite to the side where the base 411 is located). For example, the shell plate 310 covers at least a part of an upper surface of the ground bar 441 and is directly connected to the upper surface of the ground bar 441 by soldering or the like. The shell plate 320 covers at least a part of a lower surface of the inner shell 412 and is directly connected to the lower surface of the inner shell 412 by soldering or the like.

A shell 4 is formed by the outer shell 300 and the inner shell 412. The shell 4 surrounds the plurality of signal contacts 420 and the one or more ground contacts 430 about the mating orientation D1. The shell 4 includes a shell plate 310 (first shell plate) and a shell plate 413 (second shell plate) that face each other along the orthogonal orientation D3. The shell plate 310 is included in the outer shell 300, and the shell plate 413 is included in the inner shell 412. As described above, the shell plate 310 is connected to the ground bar 441, and the shell plate 413 is connected to the second ground bar 451. The shell 4 may not be divided into the outer shell 300 and the inner shell 412, and may be integrally formed.

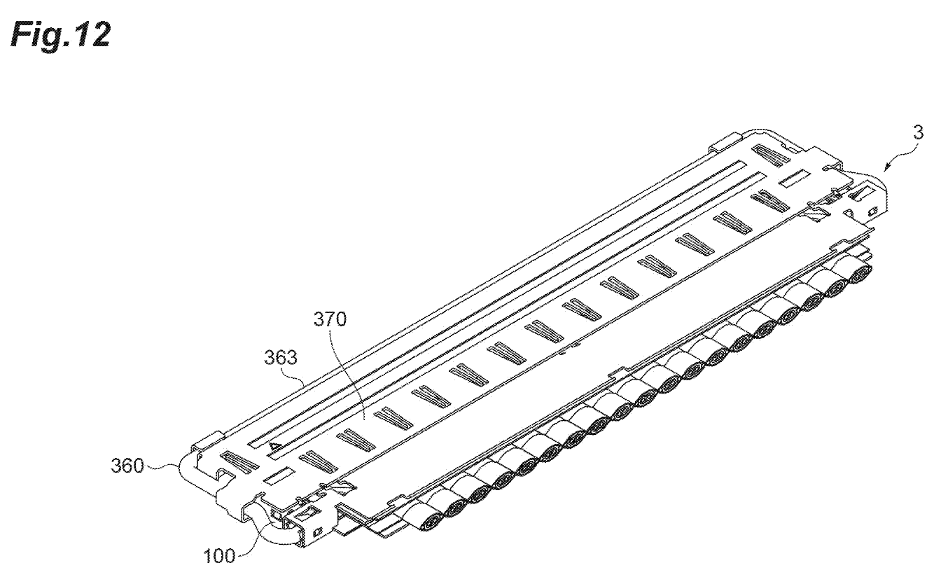

The outer shell 300 may further include a cover 370. The cover 370 has conductivity, extends along the mating orientation D1 and the arrangement orientation D2 in a state in which the connection bar 363 of the lock bar 360 is disposed at the lock position, and covers the mate connector 100 from above (see FIG. 12). The cover 370 is formed, for example, by press working and bending of a thin metal plate material such as copper, and is attached to the lock bar 360.

### Assembly Procedure of Cable Assembly

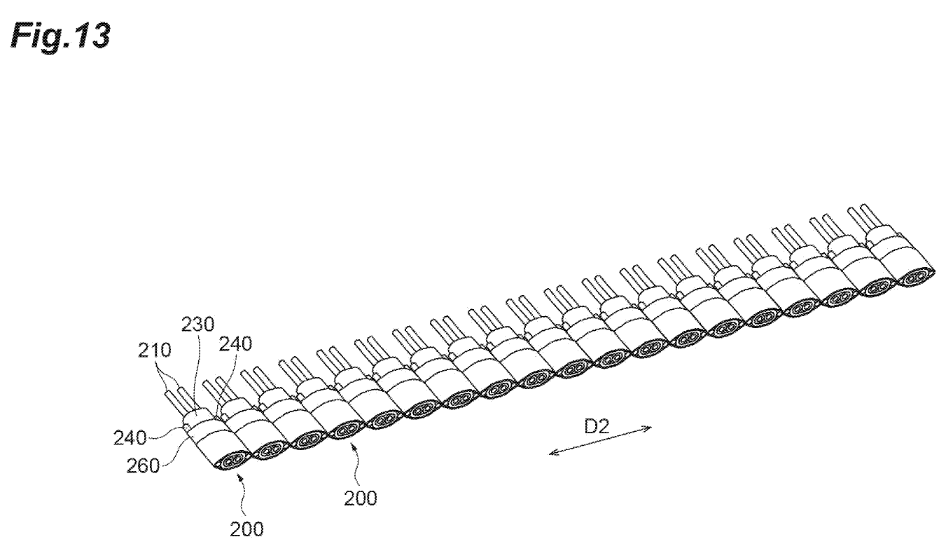

As an example of a method for manufacturing the cable assembly 2, an assembly procedure of one end of the cable assembly 2 is illustrated. As illustrated in FIG. 13, an end portion in which the exposed signal wire 210, the exposed inner sheath 230, and the exposed outer conductor 260 are arranged in this order from an end of the signal wire 210 is formed in each of the plurality of cables 200. At the end portion of each of the plurality of cables 200, the pair of drain wires 240, 240 are cut such that the respective ends of the pair of drain wires 240, 240 are located between the end of the exposed inner sheath 230 and the end of the exposed outer conductor 260. Next, the end portions of the plurality of cables 200 are arranged along the arrangement orientation D2 such that the pair of drain wires 240, 240 and the pair of signal wires 210, 210 are arranged along the arrangement orientation D2 in each of the plurality of cables 200.

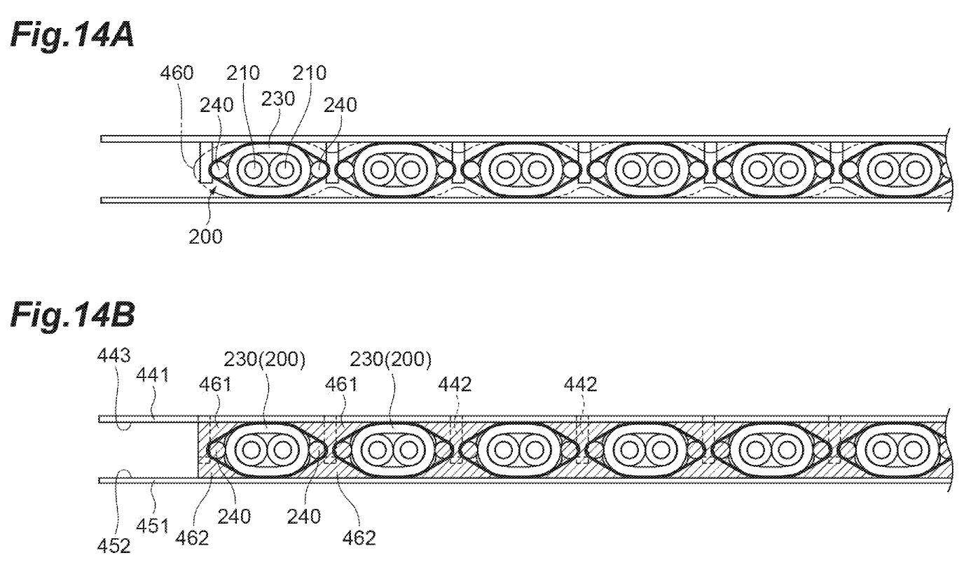

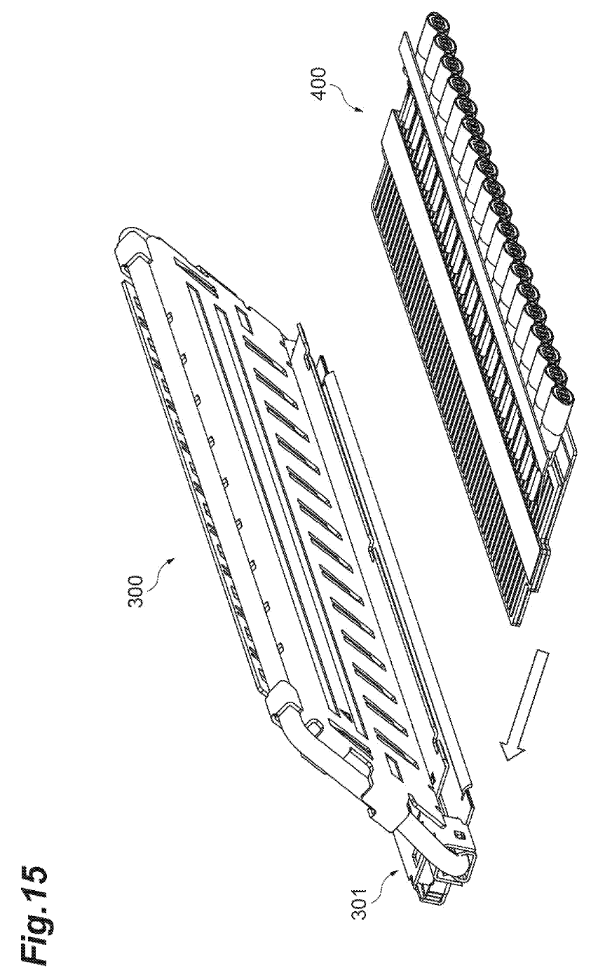

Next, as illustrated in FIG. 14A, solder paste 460 is applied to the pair of drain wires 240 exposed of each of the plurality of cables 200. The facing surface 443 of the ground bar 441 is positioned to face the inner sheath 230, and the second facing surface 452 of the second ground bar 451 is positioned to face the inner sheath 230, such that the exposed inner sheath 230 in each of the plurality of cables 200 is located between the facing surface 443 of the ground bar 441 and the second facing surface 452 of the second ground bar 451. Next, the solder paste 460 is heated and melted by reflow heating such as pulse heat. As a result, as illustrated in FIG. 14B, solder 461 is filled between the drain wire 240 and the ground bar 441 (between the drain wire 240 and the facing surface 443), and solder 462 is filled between the drain wire 240 and the second ground bar 451 (between the drain wire 240 and the second facing surface 452). The drain wire 240 is directly connected to both the ground bar 441 and the second ground bar 451 by the solder 461 and the solder 462. Next, the pair of signal wires 210, 210 exposed of each of the plurality of cables 200 are respectively directly connected to the corresponding pair of signal contacts 420 by soldering. Each of the plurality of connection pieces 442 is directly connected to the corresponding ground contact 430 by soldering. Next, as illustrated in FIG. 15, the inner unit 400 is inserted into the main body 301 from the rear. The assembly of one end of the cable assembly 2 is thus completed.

The above disclosure includes following configurations.

(1) A cable assembly 2 including: a plurality of cables 200 arranged along an arrangement orientation D2; and a connector 3 connected to the plurality of cables 200, wherein each of the plurality of cables 200 includes: a conductive signal wire 210 and a drain wire 240 that intersect the arrangement orientation D2; an insulating inner sheath 230 that covers the signal wire 210; a conductive outer conductor 260 that covers the inner sheath 230 and the drain wire 240; and an insulating outer sheath 270 that covers the outer conductor 260, wherein exposed portions of the signal wire 210, the inner sheath 230, and the outer conductor 260 are arranged in this order from an end of the signal wire 210, and an end of the exposed drain wire 240 is located between an end of the inner sheath 230 and an end of the outer conductor 260, wherein the connector 3 includes: a plurality of conductive signal contacts 420 arranged along the arrangement orientation D2; one or more conductive ground contacts 430 located between adjacent ones of the plurality of signal contacts 420 along the arrangement orientation D2; a conductive ground bar 441 extending along the arrangement orientation D2 so as to span the plurality of cables 200; and one or more connection pieces 442 that protrude from the ground bar 441 and are respectively connected to the one or more ground contacts 430, wherein the plurality of signal contacts 420 are respectively connected to a plurality of signal wires exposed of the plurality of cables 200, wherein the ground bar 441 includes a facing surface 443 that faces outer circumferential surfaces of a plurality of inner sheaths 230 exposed of the plurality of cables 200, and wherein a plurality of drain wires 240 exposed of the plurality of cables 200 are connected to the facing surface 443.

By a configuration in which the drain wire 240 of each of the plurality of cables 200 is connected to the one or more ground contacts 430 via the one or more connection pieces 442, a size of the connector 3 along the arrangement orientation D2 can be suppressed. By grouping the signal wire 210 and the drain wire 240 in a direction toward which the facing surface 443 faces, a size of the connector 3 along a direction perpendicular to the facing surface 443 can be suppressed. Since the end of the exposed drain wire 240 is located between the end of the exposed inner sheath 230 and the exposed outer conductor 260, the drain wire 240 can readily be connected to the facing surface 443 in a state in which insulation between the drain wire 240 and the signal wire 210 is maintained by the inner sheath 230. Therefore, an increase in size of the connector 3 can be suppressed. In addition, the drain wires 240 of the plurality of cables 200 can readily be connected to a ground conductor.

(2) A cable assembly 2 including: a plurality of cables 200 arranged along an arrangement orientation D2; and a connector 3 connected to the plurality of cables 200, wherein each of the plurality of cables 200 includes: a conductive signal wire 210 and a drain wire 240 that intersect the arrangement orientation D2; an insulating inner sheath 230 that covers the signal wire 210; a conductive outer conductor 260 that covers the inner sheath 230; and an insulating outer sheath 270 that covers the outer conductor 260 and the drain wire 240, wherein exposed portions of the signal wire 210, the inner sheath 230, and the outer conductor 260 are arranged in this order from an end of the signal wire 210, and an end of the exposed drain wire 240 is located between an end of the inner sheath 230 and an end of the outer conductor 260, wherein the connector 3 includes: a plurality of conductive signal contacts 420 arranged along the arrangement orientation D2; one or more conductive ground contacts 430 located between adjacent ones of the plurality of signal contacts 420 along the arrangement orientation D2; a conductive ground bar 441 extending along the arrangement orientation D2 so as to span the plurality of cables 200; and one or more connection pieces 442 that protrude from the ground bar 441 and are respectively connected to the one or more ground contacts 430, wherein the plurality of signal contacts 420 are respectively connected to a plurality of signal wires 210 exposed of the plurality of cables 200, wherein the ground bar 441 includes a facing surface 443 that faces outer circumferential surfaces of a plurality of inner sheaths 230 exposed of the plurality of cables 200, and wherein a plurality of drain wires 240 exposed of the plurality of cables 200 are connected to the facing surface 443.

Similarly to the cable assembly 2 described in (1), an increase in size of the connector 3 can be suppressed. In addition, the drain wires 240 of the plurality of cables 200 can readily be connected to a ground conductor.

(3) The cable assembly 2 according to (1) or (2), wherein, in each of the plurality of cables 200, the drain wire 240 is arranged along the arrangement orientation D2 with the signal wire 210.

By utilizing a space between the signal wire 210 and the signal wire 210 as a space for arranging the drain wire 240, a reduction in height of the connector 3 can be achieved.

(4) The cable assembly 2 according to (3), wherein the number of the one or more connection pieces 442 is smaller than the number of the drain wires 240.

The number of the ground contacts 430 can be reduced, and miniaturization of the connector 3 can be achieved.

(5) The cable assembly 2 according to (4), wherein the plurality of cables 200 are arranged such that, between two adjacent cables 200, the drain wires 240 face each other along the arrangement orientation D2, and wherein the connector 3 includes one connection piece 442 for each combination of drain wires 240 that face each other along the arrangement orientation D2.

By connecting each of the drain wires 240 of the plurality of cables 200 near the connection piece 442, stability of the potentials of the drain wires 240 can be improved.

(6) The cable assembly 2 according to (5), wherein each of the plurality of cables 200 includes a pair of the drain wires 240, and wherein the signal wire 210 is located, along the arrangement orientation D2, between the pair of the drain wires 240.

By connecting each of the pair of drain wires 240 in each of the plurality of cables 200 near the connection piece 442, stability of potentials of the pairs of drain wires 240 can be improved.

(7) The cable assembly 2 according to any one of (1) to (6), wherein each of the plurality of cables 200 includes a pair of the signal wires 210, and further includes a pair of insulating individual sheaths 220 that respectively cover the pair of signal wires 210, and wherein the inner sheath 230 covers the pair of individual sheaths 220.

Reliability of signal transmission can be further improved by a differential signal between the pair of signal wires 210.

(8) The cable assembly 2 according to any one of (1) to (7), wherein the connector 3 further includes a conductive second ground bar 451 extending along the arrangement orientation D2 so as to span the plurality of cables 200, wherein the second ground bar 451 includes a second facing surface 452 that faces outer circumferential surface of the inner sheath 230 exposed of each of the plurality of cables 200, wherein the inner sheath 230 exposed of each of the plurality of cables 200 is located between the facing surface 443 and the second facing surface 452, and wherein the exposed drain wire 240 of each of the plurality of cables 200 is connected to both the facing surface 443 and the second facing surface 452.

Stability of a potential of the drain wire 240 can be further improved.

(9) The cable assembly 2 according to (8), wherein the exposed drain wire 240 of each of the plurality of cables 200 is connected to both the ground bar 441 and the second ground bar 451 by solder filled between the drain wire 240 and the ground bar 441 and solder filled between the drain wire 240 and the second ground bar 451.

Stability of a potential of the drain wire 240 can be further improved.

(10) The cable assembly 2 according to (8) or (9), wherein the connector 3 further includes a conductive shell 4 that surrounds the plurality of signal contacts 420 and the one or more ground contacts 430 about a mating orientation perpendicular to the arrangement orientation D2, wherein the shell 4 includes a first shell plate 310 and a second shell plate 413 that face each other along an orthogonal orientation perpendicular to the arrangement orientation D2 and the mating orientation D1, and wherein the first shell plate 310 is connected to the ground bar 441 and the second shell plate 413 is connected to the second ground bar 451.

The drain wire 240 of each of the plurality of cables 200 can readily be connected to the shell 4 via the ground bar 441 and the second ground bar 451.

(11) The cable assembly 2 according to (10), wherein the connector 3 further includes an insulating base 411 that supports the plurality of signal contacts 420 and the one or more ground contacts 430, wherein the shell 4 includes: an inner shell 412 fixed to the base 411; and an outer shell 300 that is separate from the inner shell 412 and surrounds the inner shell 412 and the base 411 about the mating orientation D1, and wherein the first shell plate 310 is included in the outer shell 300 and the second shell plate 413 is included in the inner shell 412.

Both shielding performance by the shell 4 and assemblability can be achieved.

(12) The cable assembly 2 according to (11), wherein the base 411 extends along the arrangement orientation D2 and the mating orientation D1 so as to partition between the plurality of signal contacts 420 and the one or more ground contacts 430, and the inner shell 412, and wherein the outer shell 300 is connected to the inner shell 412 from a side opposite to a side where the base 411 is located.

Both shielding performance by the shell 4 and assemblability can be further achieved.

(13) The cable assembly 2 according to any one of (1) to (12), wherein the plurality of signal contacts 420 and the one or more ground contacts 430 are arranged at a constant pitch along the arrangement orientation D2.

A configuration in which the drain wire 240 is connected to the ground contact 430 via the connection piece 442 can be used to accommodate a constant pitch.

(14) The cable assembly 2 according to any one of (1) to (13), wherein the ground bar 441 includes a first edge 444 directed toward an end of the signal wire 210 and a second edge 445 directed toward an end of the outer sheath 270, and wherein an end of the exposed inner sheath 230 is located between the end of the exposed signal wire 210 and the first edge 444.

Reliability of insulation between the signal wire 210 and the drain wire 240 can be improved.

(15) The cable assembly 2 according to (14), wherein an end of the exposed outer conductor 260 is located between the first edge 444 and the second edge 445.

The ground bar 441 can also be used for holding the outer conductor 260.

(16) The cable assembly 2 according to (1) or (2), wherein each of the plurality of cables 200 includes a pair of the signal wires 210 arranged along the arrangement orientation D2 and a pair of the inner sheaths 230 that respectively cover the pair of signal wires 210.

(17) The cable assembly 2 according to (16), wherein a center CP1 of the drain wire 240 is located, in the arrangement orientation D2, between centers CP2 of the pair of the signal wires 210.

(18) The cable assembly 2 according to (17), wherein the center CP1 of the drain wire 240 is located, in an orthogonal orientation D3 perpendicular to the arrangement orientation D2 and the mating orientation D1, between each of the centers CP2 of the pair of the signal wires 210 and the ground bar 441.

(19) The cable assembly 2 according to (17), wherein each of the centers CP2 of the pair of the signal wires 210 is located, in an orthogonal orientation D3 perpendicular to the arrangement orientation D2 and the mating orientation D1, between the center CP1 of the drain wire 240 and the ground bar 441.

(20) The cable assembly 2 according to (17), wherein each of the plurality of cables 200 includes a pair of the drain wires 240, and wherein each of the centers CP2 of the pair of the signal wires 210 is located, in an orthogonal orientation D3 perpendicular to the arrangement orientation D2 and the mating orientation D1, between centers CP1 of the pair of the drain wires 240.

(21) A method for manufacturing a cable assembly 2 by attaching a connector 3 to a plurality of cables 200 each including a conductive signal wire 210 and a drain wire 240, an insulating inner sheath 230 that covers the signal wire 210, a conductive outer conductor 260 that covers the inner sheath 230 and the drain wire 240, and an insulating outer sheath 270 that covers the outer conductor 260, the method including: forming, in each of the plurality of cables 200, an end portion in which exposed portions of the signal conductor, the inner sheath 230, and the outer conductor 260 are arranged in this order from an end of the signal conductor; cutting the drain wire 240 such that, at the end portion of each of the plurality of cables 200, an end of the drain wire 240 is located between an end of the exposed inner sheath 230 and an end of the exposed outer conductor 260; arranging the plurality of cables 200 along an arrangement orientation D2; causing a facing surface 443 of a ground bar 441 extending along the arrangement orientation D2 to face the inner sheath 230 exposed of each of the plurality of cables 200; connecting the drain wire 240 exposed of each of the plurality of cables 200 to the facing surface 443; connecting the signal wire 210 exposed of each of the plurality of cables 200 to any of a plurality of signal contacts 420 arranged along the arrangement orientation D2; and connecting one or more connection pieces 442 protruding from the ground bar 441 respectively to one or more conductive ground contacts 430 located between adjacent ones of the plurality of signal contacts 420 along the arrangement orientation D2.

(22) A method for manufacturing a cable assembly 2 by attaching a connector 3 to a plurality of cables 200 each including a conductive signal wire 210 and a drain wire 240, an insulating inner sheath 230 that covers the signal wire 210, a conductive outer conductor 260 that covers the inner sheath 230, and an insulating outer sheath 270 that covers the outer conductor 260 and the drain wire 240, the method including: forming, in each of the plurality of cables 200, an end portion in which exposed portions of the signal wire 210, the inner sheath 230, and the outer conductor 260 are arranged in this order from an end of the signal conductor; cutting the drain wire 240 such that, at the end portion of each of the plurality of cables 200, an end of the drain wire 240 is located between an end of the exposed inner sheath 230 and an end of the exposed outer conductor 260; arranging the plurality of cables 200 along an arrangement orientation D2; causing a facing surface 443 of a ground bar 441 extending along the arrangement orientation D2 to face the inner sheath 230 exposed of each of the plurality of cables 200; connecting the drain wire 240 exposed of each of the plurality of cables 200 to the facing surface 443; connecting the signal wire 210 exposed of each of the plurality of cables 200 to any of a plurality of signal contacts 420 arranged along the arrangement orientation D2; and connecting one or more connection pieces 442 protruding from the ground bar 441 respectively to one or more conductive ground contacts 430 located between adjacent ones of the plurality of signal contacts 420 along the arrangement orientation D2.

(23) The method of manufacturing a cable assembly 2 according to (21) or (22), further including: applying solder paste 460 to the exposed drain wire 240 in each of the plurality of cables 200; and causing a second facing surface 452 of a conductive second ground bar 451 extending along the arrangement orientation D2 to face the exposed inner sheath 230 in each of the plurality of cables 200 such that the exposed inner sheath 230 in each of the plurality of cables 200 is located between the second facing surface 452 and the facing surface 443, wherein, when connecting the drain wire 240 of each of the plurality of cables 200 to the facing surface 443, the applied solder paste 460 is heated and melted so as to connect the drain wire 240 to both the facing surface 443 and the second facing surface 452.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A cable assembly comprising:
a plurality of cables arranged along an arrangement orientation; and
a connector connected to the plurality of cables,
wherein each of the plurality of cables comprises:
a conductive signal wire and a drain wire that intersect the arrangement orientation;
an insulating inner sheath that covers the signal wire;
a conductive outer conductor that covers the inner sheath; and
an insulating outer sheath that covers the outer conductor and the drain wire,
wherein exposed portions of the signal wire, the inner sheath, and the outer conductor are arranged in this order from an end of the signal wire, and an end of the exposed drain wire is located between an end of the inner sheath and an end of the outer conductor,
wherein the connector comprises:
a plurality of conductive signal contacts arranged along the arrangement orientation;
one or more conductive ground contacts located between adjacent ones of the plurality of signal contacts along the arrangement orientation;
a conductive ground bar extending along the arrangement orientation so as to span the plurality of cables; and
one or more connection pieces that protrude from the ground bar and are respectively connected to the one or more ground contacts,
wherein the plurality of signal contacts are respectively connected to a plurality of signal wires exposed of the plurality of cables,
wherein the ground bar comprises a facing surface that faces outer circumferential surfaces of a plurality of inner sheaths exposed of the plurality of cables, and
wherein a plurality of drain wires exposed of the plurality of cables are connected to the facing surface.

2. The cable assembly according to claim 1, wherein the outer conductor covers the drain wire.

3. The cable assembly according to claim 1, wherein, in each of the plurality of cables, the drain wire is arranged side-by side with the signal wire along the arrangement orientation.

4. The cable assembly according to claim 3, wherein the number of the one or more connection pieces is smaller than the number of the drain wires.

5. The cable assembly according to claim 4, wherein the plurality of cables are arranged such that, between two adjacent cables, the drain wires face each other along the arrangement orientation, and
wherein the connector comprises one connection piece for each combination of drain wires that face each other along the arrangement orientation.

6. The cable assembly according to claim 5, wherein each of the plurality of cables comprises a pair of the drain wires, and
wherein the signal wire is located, along the arrangement orientation, between the pair of the drain wires.

7. The cable assembly according to claim 1, wherein each of the plurality of cables comprises a pair of the signal wires, and further comprises a pair of insulating individual sheaths that respectively cover the pair of signal wires, and
wherein the inner sheath covers the pair of individual sheaths.

8. The cable assembly according to claim 1, wherein the connector further comprises a conductive second ground bar extending along the arrangement orientation so as to span the plurality of cables,
wherein the second ground bar comprises a second facing surface that faces outer circumferential surfaces of the inner sheath exposed of each of the plurality of cables,
wherein the inner sheath exposed of each of the plurality of cables is located between the facing surface and the second facing surface, and
wherein the drain wire exposed of each of the plurality of cables is connected to both the facing surface and the second facing surface.

9. The cable assembly according to claim 8, wherein the exposed drain wire in each of the plurality of cables is connected to both the ground bar and the second ground bar by solder filled between the drain wire and the ground bar and solder filled between the drain wire and the second ground bar.

10. The cable assembly according to claim 8, wherein the connector further comprises a conductive shell that surrounds the plurality of signal contacts and the one or more ground contacts about a mating orientation perpendicular to the arrangement orientation,
wherein the shell comprises a first shell plate and a second shell plate that face each other along an orthogonal orientation perpendicular to the arrangement orientation and the mating orientation, and
wherein the first shell plate is connected to the ground bar and the second shell plate is connected to the second ground bar.

11. The cable assembly according to claim 10, wherein the connector further comprises an insulating base that supports the plurality of signal contacts and the one or more ground contacts,
wherein the shell comprises:
an inner shell fixed to the base; and
an outer shell that is separate from the inner shell and surrounds the inner shell and the base about the mating orientation, and
wherein the first shell plate is included in the outer shell and the second shell plate is included in the inner shell.

12. The cable assembly according to claim 11, wherein the base extends along the arrangement orientation and the mating orientation so as to partition the plurality of signal contacts and the one or more ground contacts from the inner shell, and
wherein the outer shell is connected to the inner shell from a side opposite to a side where the base is located.

13. The cable assembly according to claim 1, wherein the plurality of signal contacts and the one or more ground contacts are arranged at a constant pitch along the arrangement orientation.

14. The cable assembly according to claim 1, wherein the ground bar comprises a first edge directed toward an end of the signal wire and a second edge directed toward an end of the outer sheath, and
wherein an end of the exposed inner sheath is located between the end of the exposed signal wire and the first edge.

15. The cable assembly according to claim 14, wherein an end of the exposed outer conductor is located between the first edge and the second edge.

16. The cable assembly according to claim 1, wherein each of the plurality of cables comprises a pair of the signal wires arranged along the arrangement orientation and a pair of the inner sheaths that respectively cover the pair of signal wires.

17. The cable assembly according to claim 16, wherein a center of the drain wire is located, in the arrangement orientation, between centers of the pair of the signal wires.

18. The cable assembly according to claim 17, wherein the center of the drain wire is located, in an orthogonal orientation perpendicular to the arrangement orientation, between each of the centers of the pair of the signal wires and the ground bar.

19. The cable assembly according to claim 17, wherein each of the centers of the pair of the signal wires is located, in an orthogonal orientation perpendicular to the arrangement orientation, between the center of the drain wire and the ground bar.

20. The cable assembly according to claim 17, wherein each of the plurality of cables comprises a pair of the drain wires, and
wherein each of the centers of the pair of the signal wires is located, in an orthogonal orientation perpendicular to the arrangement orientation, between centers of the pair of the drain wires.

21. A method for manufacturing a cable assembly by attaching a connector to a plurality of cables each comprising a conductive signal wire and a drain wire, an insulating inner sheath that covers the signal wire, a conductive outer conductor that covers the inner sheath, and an insulating outer sheath that covers the outer conductor and the drain wire, the method comprising:
forming, in each of the plurality of cables, an end portion in which exposed portions of the signal wire, the inner sheath, and the outer conductor are arranged in this order from an end of a signal wire;
cutting the drain wire such that, at the end portion of each of the plurality of cables, an end of the drain wire is located between an end of the exposed inner sheath and an end of the exposed outer conductor;
arranging the plurality of cables along an arrangement orientation;
causing a facing surface of a ground bar extending along the arrangement orientation to face the inner sheath exposed of each of the plurality of cables;
connecting the drain wire exposed of each of the plurality of cables to the facing surface;
connecting the signal wire exposed of each of the plurality of cables to any of a plurality of signal contacts arranged along the arrangement orientation; and
connecting one or more connection pieces protruding from the ground bar respectively to one or more conductive ground contacts located between adjacent ones of the plurality of signal contacts along the arrangement orientation.

22. The method of manufacturing a cable assembly according to claim 21, further comprising:
applying solder paste to the exposed drain wire in each of the plurality of cables; and
causing a second facing surface of a conductive second ground bar extending along the arrangement orientation to face the exposed inner sheath in each of the plurality of cables such that the exposed inner sheath in each of the plurality of cables is located between the second facing surface and the facing surface,
wherein, for said connecting the drain wire of each of the plurality of cables to the facing surface, the applied solder paste is heated and melted so as to connect the drain wire to both the facing surface and the second facing surface.
